(19) United States
(12) Patent Application Publication
(10) Pub. No.: US 2009/0087827 A1
(43) Pub. Date: Apr. 2, 2009

(54) COMPUTERIZED TESTING SYSTEM

(76) Inventor: Benjamin A. Goldburd, Brooklyn, NY (US)

Correspondence Address: Benjamin A. Goldburd, 1243 East 7th Street, Brooklyn, NY, 11230, US

(21) Appl. No.: 12/234,704

(22) Filed: Sep. 21, 2008

Related U.S. Application Data
(60) Provisional application No. 60/999,762, filed on Sep. 26, 2007.

(51) Int. Cl. G09B 7/00; H04L 9/32

(52) U.S. Cl. 434/362; 726/2

(57) ABSTRACT

A secure testing system utilizing a test taker's own notebook computer with a small portable/removable uniquely identified drive element (USB flash drive, SD card and the like) being plugged into the computer port (USB, card reader, etc.). The drive is pre-programmed with lock-out software activated with test taker log in, and preprogrammed exams or examination generations software. The drive and examination software are configured for multiple choice selection and text entry for essay answers. With exam completion the drives are removed with restoration of computer function. The individual drives are collected and connected to multiple reading ports for automatic reading and grading of multiple choice question answers and manual checking of text answers. The exams, with identification of disk drives and test taker are downloaded to an archive server and the drives are wiped clean for re-use. Test results and comments are sent via e-mail to the test taker.

### FIELD OF THE INVENTION

This invention relates to computerized test or examination administration and particularly to tests administered directly on a test taker's own notebook computer.

### BACKGROUND OF THE INVENTION

Computerized tests or examinations have been replacing the traditional paper and pen examinations, not only for grading but also with respect to actual entry of answers both of the short answer or multiple choice type and also the type of answers requiring the entry of text data.

These examinations are typically administered in several common ways. One method of test administration requires a bank of terminals with the terminals being directly connected to a server, having the appropriate testing software. The examinations are accordingly administered in a computer lab setting where the terminals are set up. Since computer control is entirely within administration hands, security is high. However, this type of system requires a set infrastructure with adequate space and number of terminals. This entails a high economic outlay, extensive maintenance and a highly constrained degree of scheduling logistics since the number of terminals is relatively few, particularly if different tests are to be administered at the same time. In addition, some test takers may be affected by non-familiar non-classroom surroundings, with a possible skewing of test results.

A second way of computerized test administration involves the use of a test Taker's own notebook computer. For logistics and security reasons this system requires the pre-preparation of the computer to make it suitable for examination taking purposes. The notebook computers are brought into IT management of the examination administration, for the downloading of testing software, prior to an examination. Alternatively, the software is downloaded from a controlled, limited access, intranet site. The software remains resident on the notebook computer and provides security by blocking internet access as well as access to notebook resident programs, documents and other files during activation of the software and the taking of the examination. The resident loaded software enables the notebook to link up to an intra-net or controlled internet for test downloading and uploading of completed examination. This system, while effective and secure, entails problems of administration and the introduction of communication lines which may be disrupted, or may be beset with problems of server down time.

### SUMMARY OF THE INVENTION

It is an object of the present invention to provide a stand alone, self contained, test administration system, a method of test administration, and the appropriate hardware and software for effective and secure test administration. The invention encompasses the system, from test preparation to test taking and grading, with test archiving and result reporting.

It is a further object of the present invention to provide such system with high security and control, without internet, intranet or other disruptable communication means or servers, and without pre-loaded software, on a computer to be used for the examination.

It is yet another object of the present invention to provide uniquely identifiable portable hard drive elements having test or test creation software pre-loaded thereon, which hard drive elements are writable with examination answers including text entry and which drive elements (and contained controlling software) automatically locks out computer function, aside from the drive element functions.

Generally the present invention comprises a test administration system fully contained within a portable, inexpensive, reusable drive element such as a USB flash drive, an SD (secure digital) memory card and the like which is self contained with newly created or imported tests from an administration on source computer, with existing tests and/or test creation software. The drive contains computer function lock out software, ID software for identifying test user identity and to initiate the computer function lock out software. The lock out software is effective while resident in the computer and activated (prior to activation, internet access is utilized to download drivers for the examination software and operation, if not contained on the USB drive). It locks out all computer functions not controlled by the drive programs, including internet access, and access to programs and data resident on the notebook computer itself. The lock out includes prevention of unauthorized duplication of the test material and entered answers during the examination. In addition, the drive software highly preferably has the ability to load a new operating system (OS) micro kernel off the drive device to control the machine on reboot. This prevents an operational security breach with computer reboot and deactivation of the lockout software. The lock out and other security software, as described, is commercially available such as from Xsides Corporation, Bellevue, Washington as a secure data display. The secure data display works by sectioning off a portion of the desktop display for a secure section removed from the actual OS and hard-drive, this allows for no interaction at all between the secure section unless explicitly allowed by the Xsides software, (i.e. word docs etc). To implement the lock out function the section encompasses the entire OS display, removing any interaction with the hard-drive and laptop systems.

The drive contains word processing software for entry of text answers and multiple choice entry and processing software. For open book examinations, the book sources are loaded onto the drive as well. The drives are multiply linked to a download source for simultaneous loading of the tests and to an upload source for automatic simultaneous grading for short answers. The drives are preferably configured to launch virtual machines, or shell user interfaces for operational compatibility with computer operating systems such as Windows with undergo periodic OS upgrades and changes (e.g., XP to Vista, etc.). This provides the broadest utility for the testing procedure of the present invention on a diverse range of test taker computers and operating systems. Word processing programs are readily available in compact simple text entry format, such as available at minimal cost in Microsoft Works®.

The USB drives are uniquely identifiable and are individually linkable to a specific test taker. Tampering with USB programs and entered data is evident, with the ability of the system to reject data from the identified drive, The present invention comprises a computerized testing system with the three modules of operation of test preparation and loading, the test taking and the test grading and archiving. The invention includes the method of of computerized testing by using the drives for the testing. The present invention further comprises the drives with unique identification and with preloaded software for operative testing procedures and security within the confines of the drive.

The present invention comprises a method for computerized administration of examinations on a notebook computer comprising the steps of:

a) providing a portable computer drive element with unique identification to identify the drive element and a user thereof, the drive element being configured for removable attachment to the notebook computer,

b) loading the portable computer drive element with the software components of:

i) examination taking software configured to permit entry and saving of examination answers by an examination taker;

ii) identity software configured to permit entry data of a user of the drive element and to correlate user identity with the drive element and contents entered thereon

iii) computer lock out software to lock out all computer functions of the notebook computer, except those controlled by software on the drive element, while the computer drive element is connected to the notebook computer and the computer lock out software is activated; and

iv) an examination;.

c) connecting the computer drive element to the notebook computer;

d) an examination taker taking the examination by:

a. logging in with identification data;

b. activating the lock out software, security software and word processing program, and

c. selecting answers from a listing of choices and/or answering text based questions with the use of the word processing software;

e) removing the computer drive element from the notebook computer and connecting the computer drive element to a reader device;

f) from the reader device validating examination details and linking entered contents on the computer drive element to the examination taker;

g) grading the examination; and

h) downloading the graded examination to an archive server.

The device of the present invention comprises the portable drive elements with soft ware of test security programs and word processing.

The present invention further comprises a computerized testing system with the method as described, utilizing the device of the present invention in three operational modules of test preparation, test taking and test grading and archiving.

These and other objects, features and advantages of the present invention will become more evident from the following discussion and drawings in which:

### SHORT DESCRIPTION OF THE DRAWINGS

FIGS. 1 to 11b are computer screen shots showings various operational aspects of the present invention:

FIGS. 1a and 1b are screen shots of sign in pages for a test administrator (for test preparation and loading as well as test grading) and of a test taker respectively.;

FIGS. 2, 2a and 2b are screen shots of menus for a series of test preparation options from a previously prepared examination and examinations being constructed;

FIG. 3 is an import examination selection option;

FIGS. 4a -4c are examination creation drag and drop options with a prepared answer key in FIG. 4b,

FIGS. 5a-c are export to USB or save menus, examination option screen and menu of number of USB devices, with validation.

FIGS. 6a and 6b are an export grid with test and download information and examination identification information and a confirmation page respectively;

FIG. 7 is a student information page with lock out information and tampering information; and

FIG. 8 is an examination fill in with multiple choice answers and an on-screen timer;

FIG. 9 is an examination grading selection by USB number;

FIG. 10 is a loading of USB devices for grading with validity notification for grading;

FIG. 11a is a grading grid with student information and USB correlation information;

FIG. 11b is the grading grid of FIG. 11a with test scores filled in;

FIG. 12 is a schematic representation of the multiple USB port unit for simultaneous loading of tests and programs and the multiple simultaneous reading and grading,

FIGS. 13a and 13b are front views of a typical USB flash drive in connector extended and retracted positions respectively, and

FIGS. 14a and 14b are front and rear views of a typical SD card respectively.

### DETAILED DESCRIPTION OF THE INVENTION AND DRAWINGS

The method of the present invention further includes optional steps of:

i) downloading a word processing program to the drive element if the examination includes text entry such as essay questions.

ii) downloading security software to the drive element to detect tampering with the drive element

iii) optionally providing the drive with “open book” material permitted to be utilized by the test taker.

The test taker or an administrator connects the computer drive elements to ports of the test takers' notebook computers. The test taker taking the exam logs in with identification data, thereby activating the lock out software, security software and word processing program. The test taker then selects answers from a listing of choices and/or answers text based questions with the use of the downloaded word processing software.

When the examination is completed, the computer drive elements are removed and collected from the notebook computers. The notebook computers are automatically reactivated to normal usage states with the removal of the drive elements. The collected drives are multiply connected to a reader device where they are validated. The drive element contents are linked to the respective test takers and the examination are graded simultaneously with short answer examinations and manually with text based answers. The marked examinations are download to an archive server and the drives are wiped clean of non-reusable test data and programs for reuse.

Generally examination systems are comprised of three processing modules:

1) a test preparation module effected by test administrators such as professors and teachers;

2) a test taking module involving the taking of the examination most commonly a student, license practice applicant or job seeker; and

3) a third module of examination involving grading by an administrator, professor or teacher, and examination archiving.

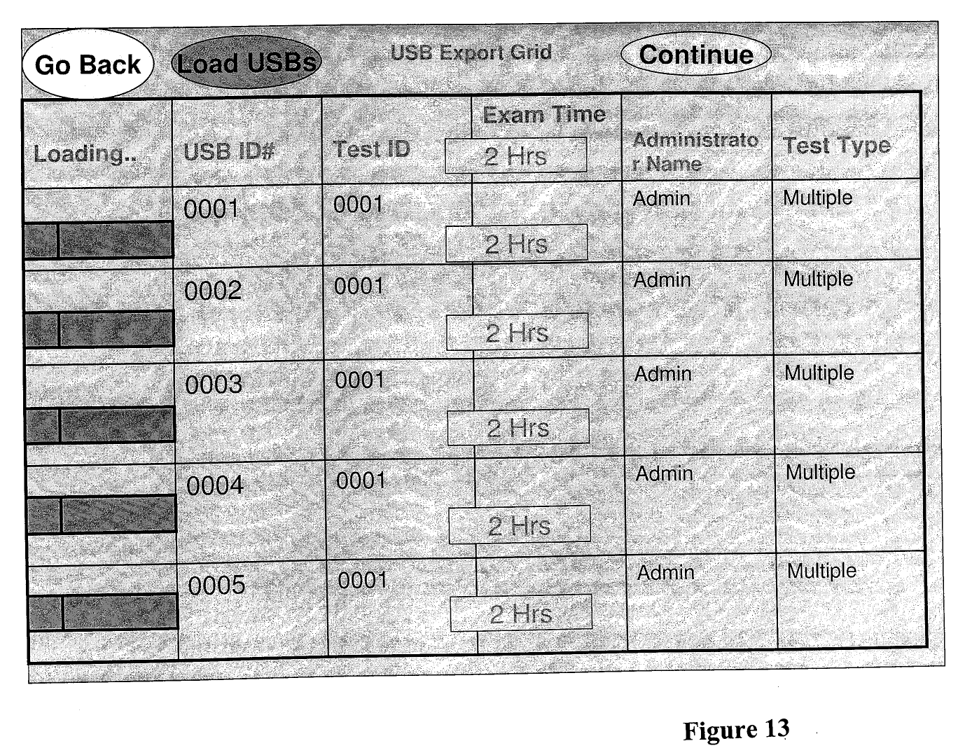

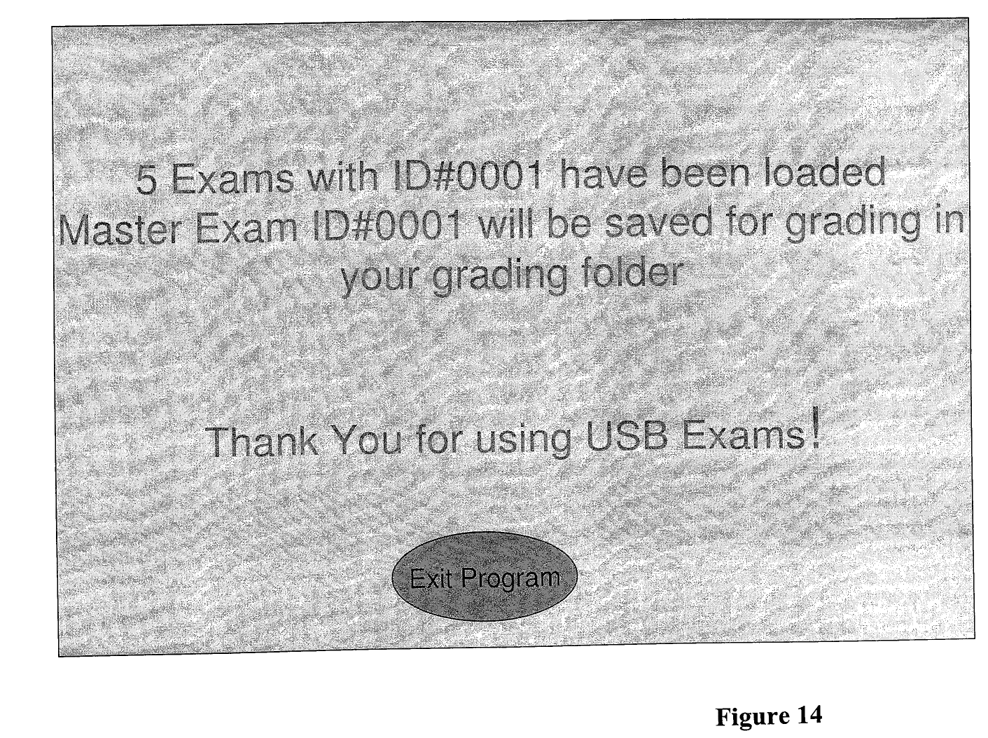

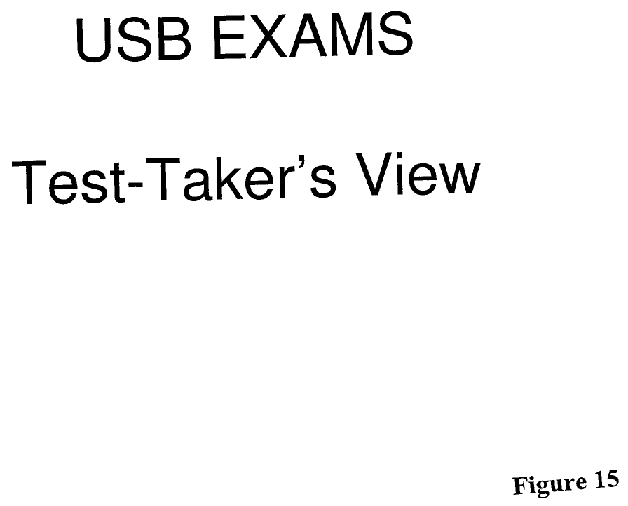

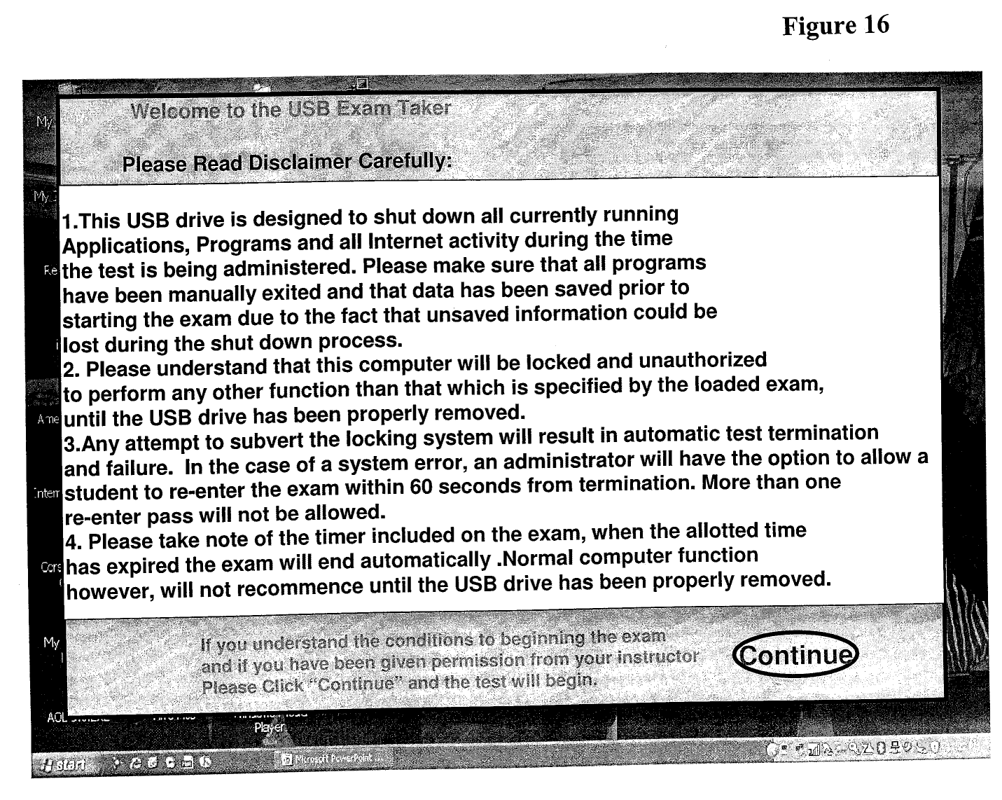

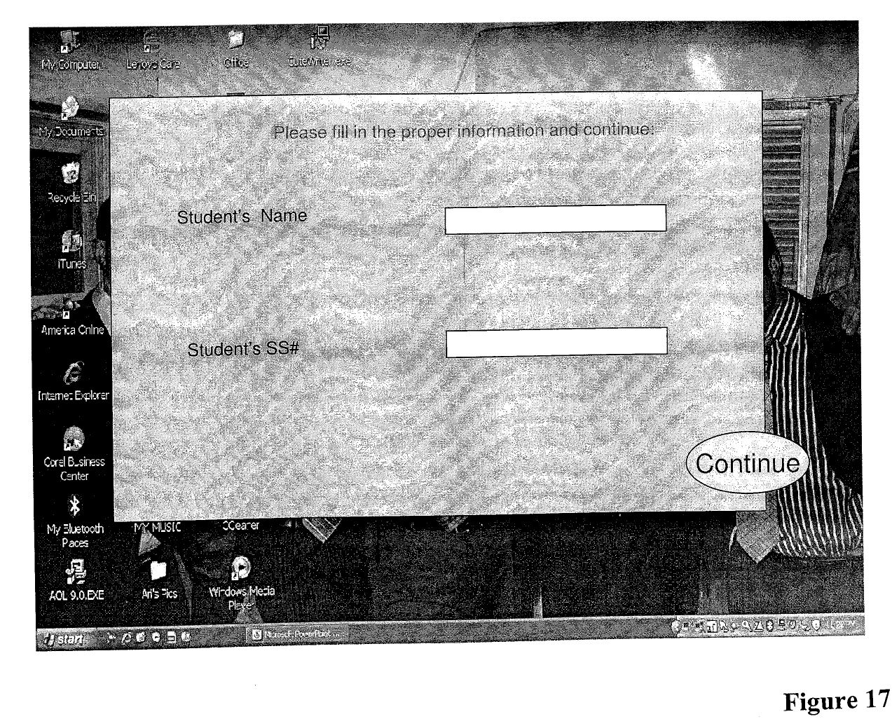

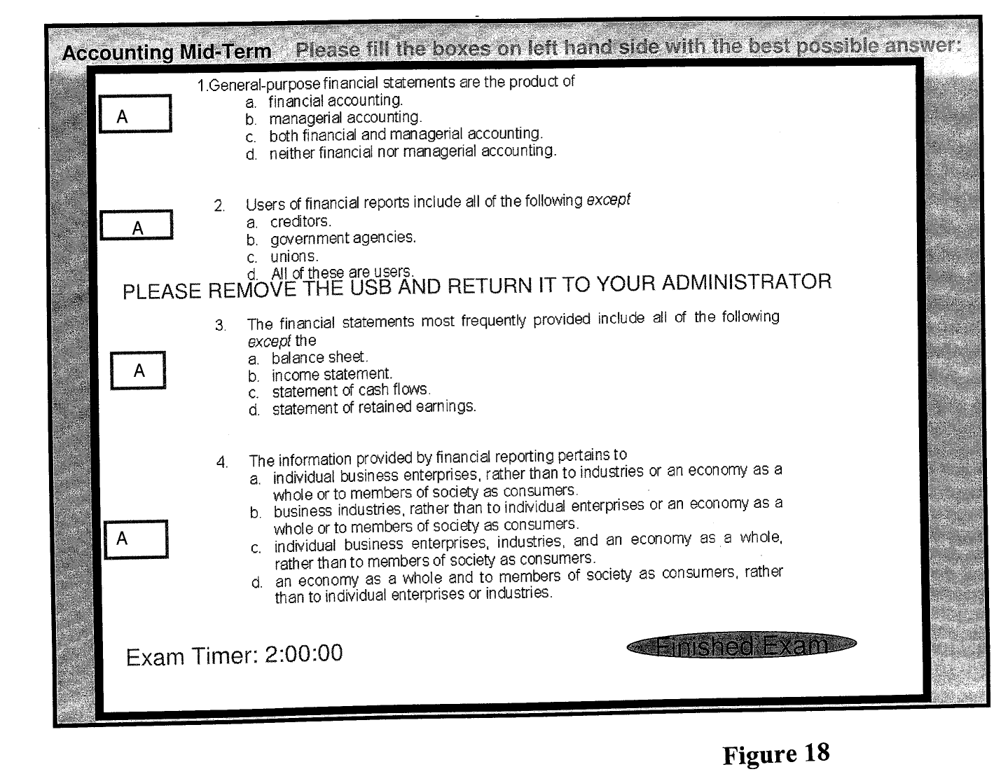

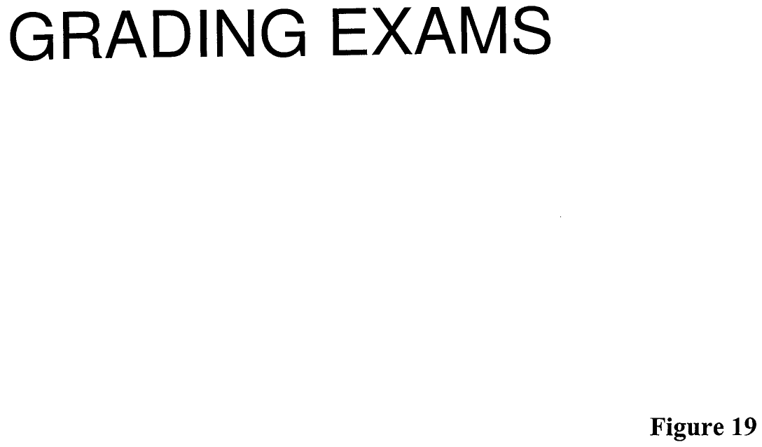

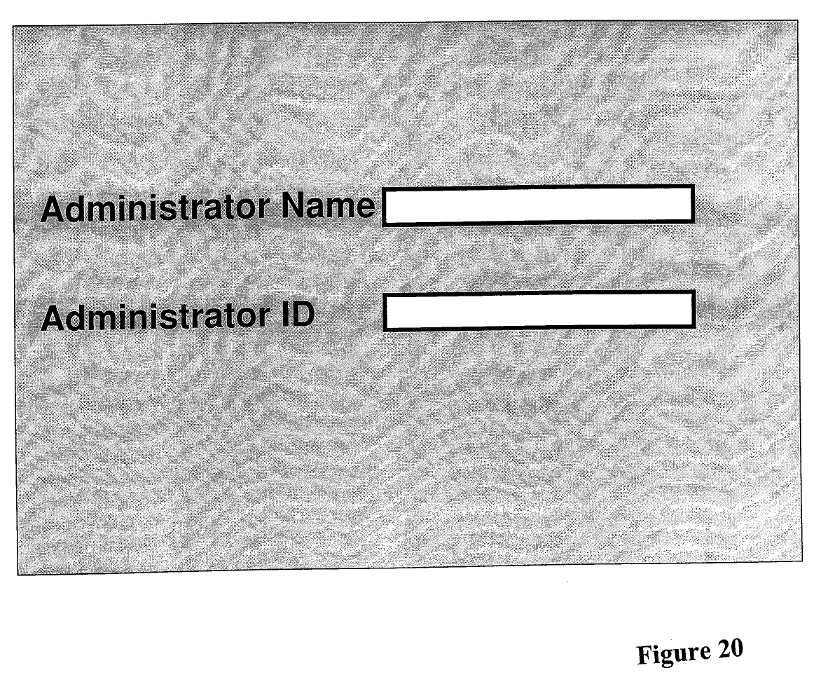

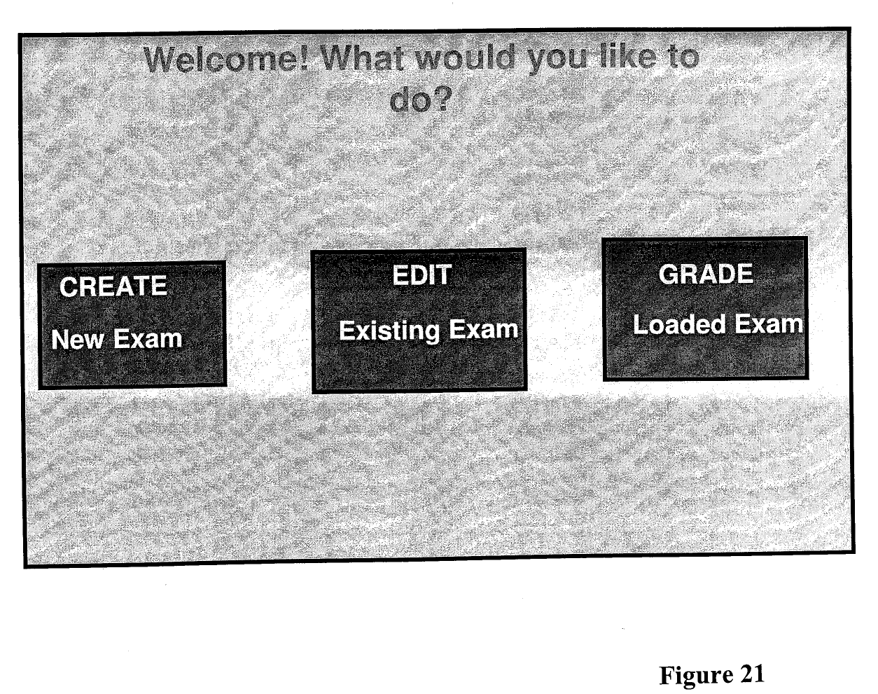

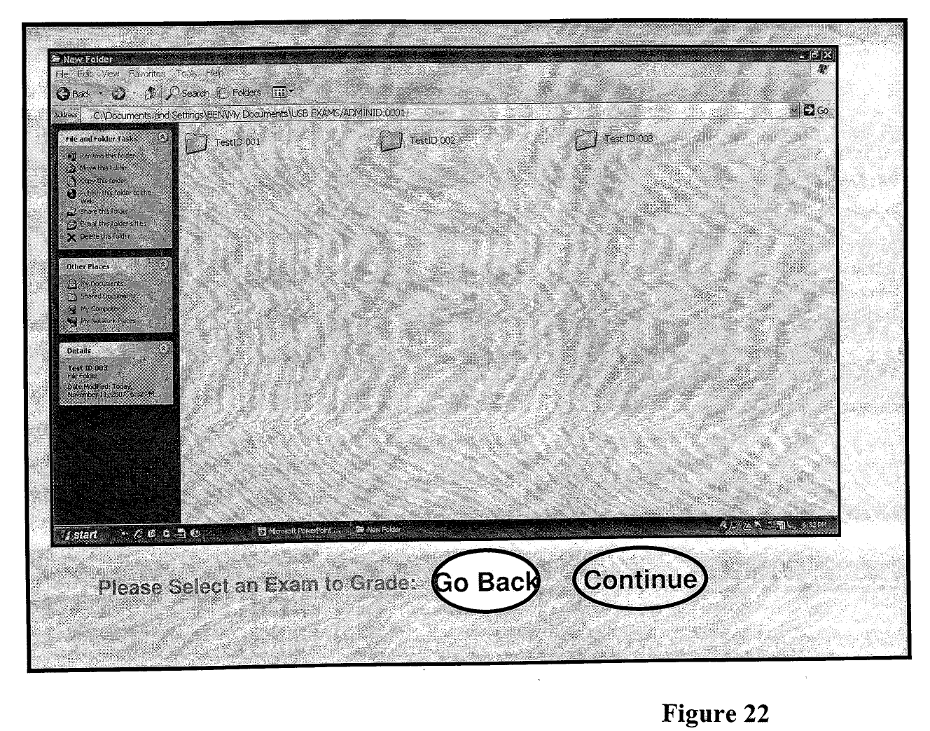

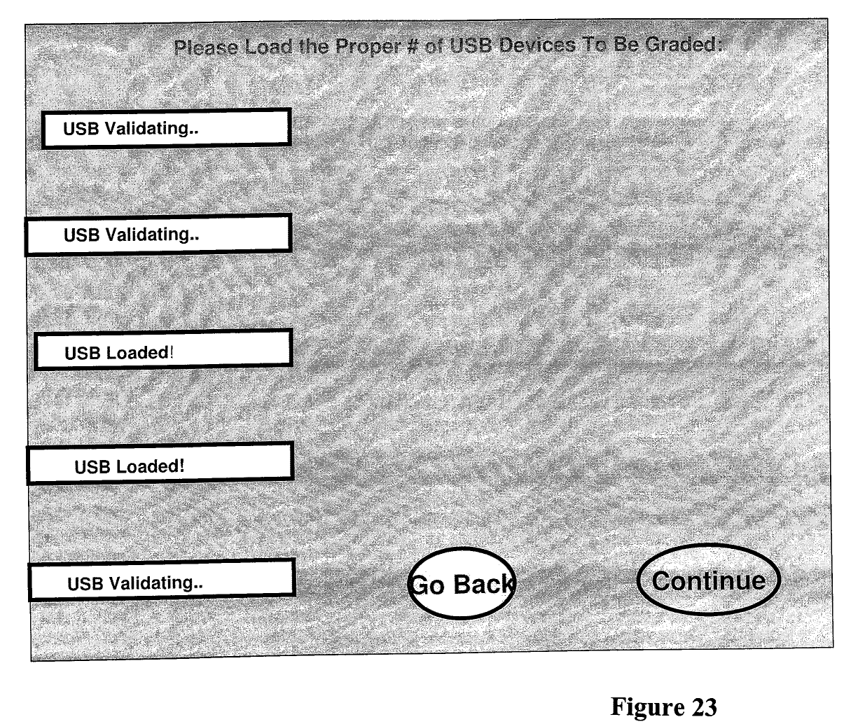

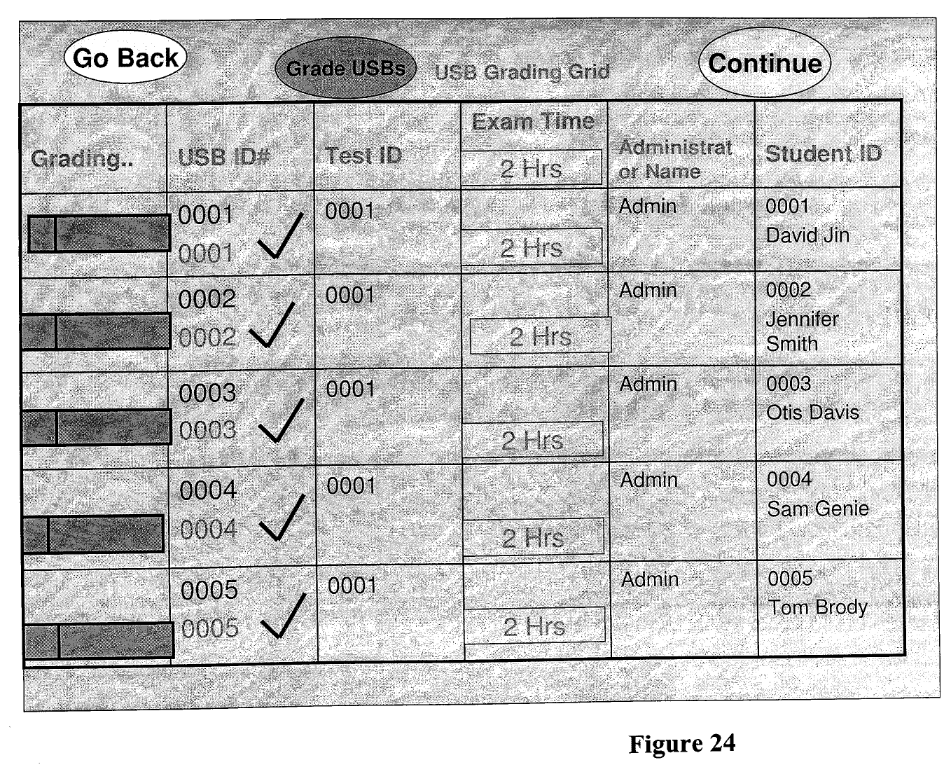

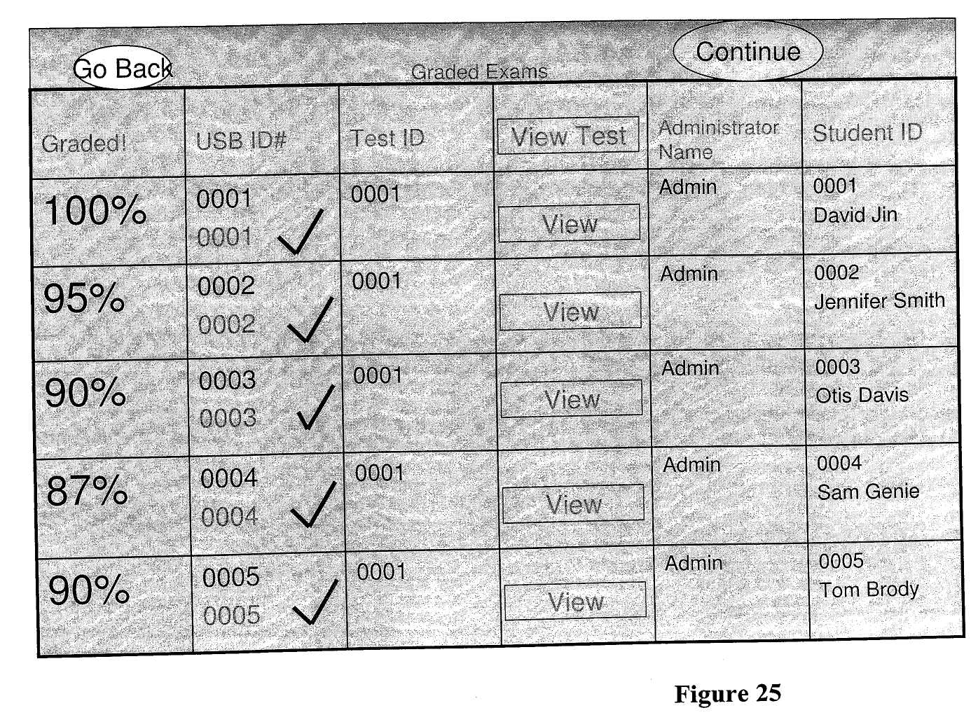

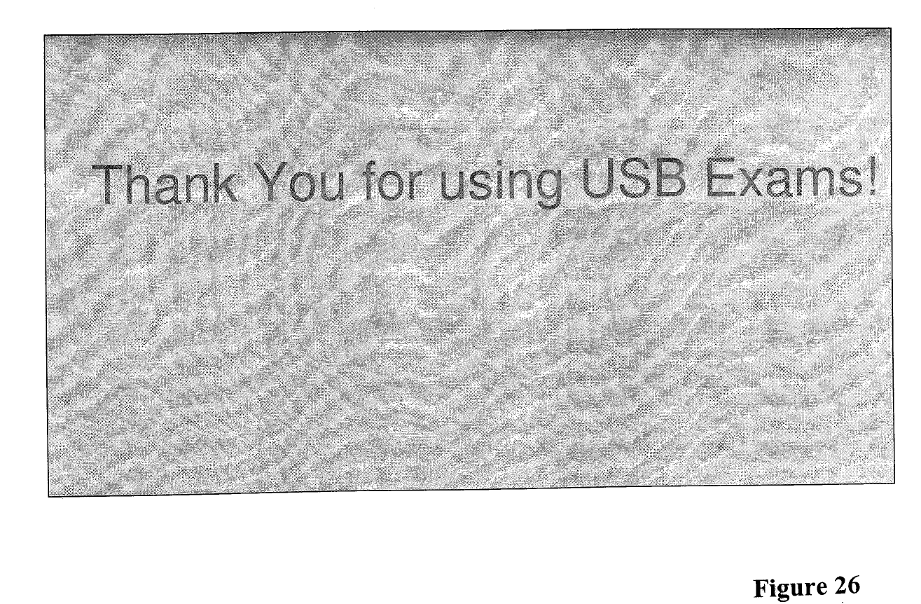

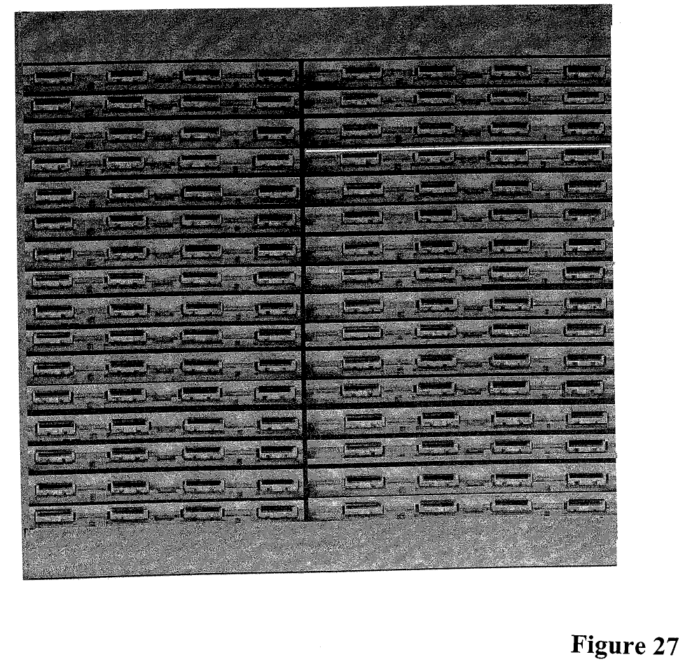

In accordance with the present invention the three modules of the examination system (except for actual examination archiving which is generally on a server set apart for such purpose) are fully contained within a portable drive element. These portable drives include USB flash drive, such as USB flash drive 10 shown in FIGS. 13a and 13b, SD card 20 such as shown in FIGS. 14 and 14b, and the like, which currently have sufficiently large storage capacity for both test security software and test storage, and word processing. Since USB ports are standard in all modern computers and flash drives are rugged, USB flash drives are preferred for use in the present invention (for convenience the following discussion refers to “USB” drives). Many computers now also have card readers or card readers can be operationally attached through a USB port. Though not limited to minimal storage requirements, it is preferred that the drives or drive elements or memory cards each have at least 300 megabytes of storage space to accommodate the requisite software and test data entry. Currently, at least a gigabyte of storage is standard for inexpensive commercially available flash drives. Programs resident on the drives are not full featured such as the text entry word processing program and require minimal storage memory or processing capability.

The drives are both externally and internally (on storage memory) marked with identification to distinguish them from other drives. For security, the external identification, such as an alphanumeric-notation (e.g., as shown in FIGS. 13a and 13b as element 11 as an etched alphanumeric identifier “A5”, is made tamperproof and either etched into plastic or metal casings or covered with tamper evident clear plastic. The drives may either be single use or may be re-used, after appropriate processing, with accommodating software licenses.

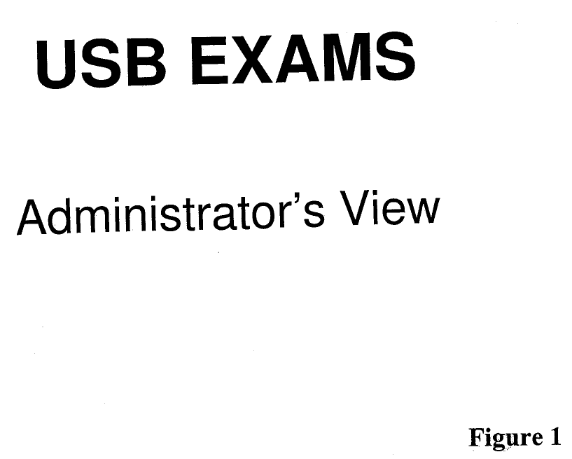

A trail of both administration processors (test preparer and grader) is provided on the drive with the operational entry in the first and third administrative log on entries as shown in FIG. 1a with entry of administrator name and id. The test taker log in for the second test taking module is that of student name and student social security number (the most commonly used student ID) as shown in FIG. 1b. Each of the log-ins is required for continued module operation.

With respect to test data security, the secure client application on the USB drive should encrypt the data reading/writing from the USB drive. Alternatively, it may use one of the libraries on the USB drive (e.g., SanDisk, Karunga, etc . . . ). This encrypted data may be the test data and/or the answers if needed to be included directly on the drive. On the Administration application, the Administrator can decrypt with a global public key for that test/admin. In addition, the student is encrypted from any read/write with regard to the drive itself and specialized encryption for the administrator to access the information through the administrative computer system.

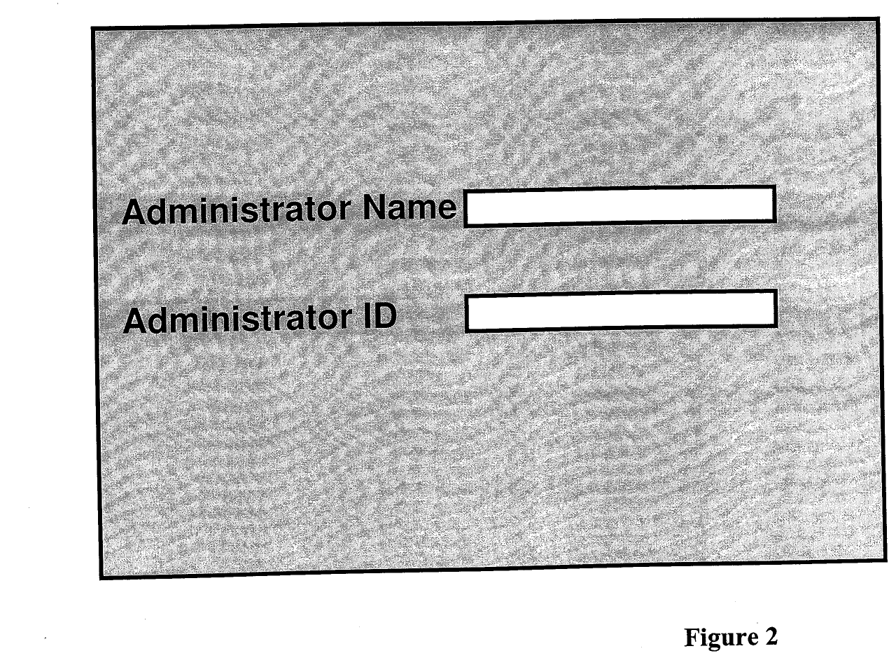

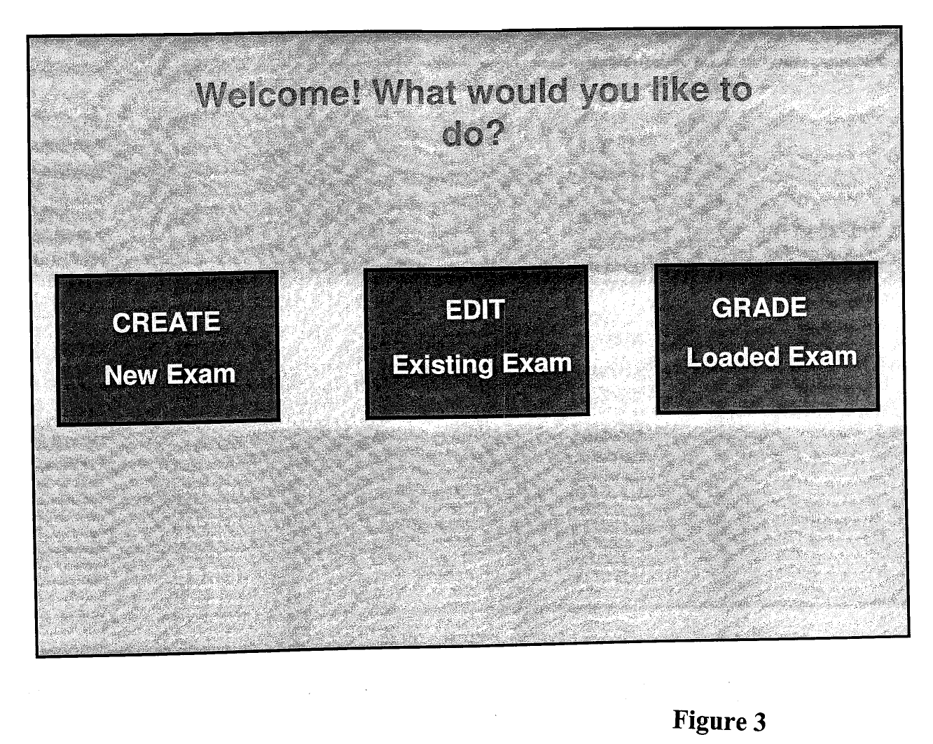

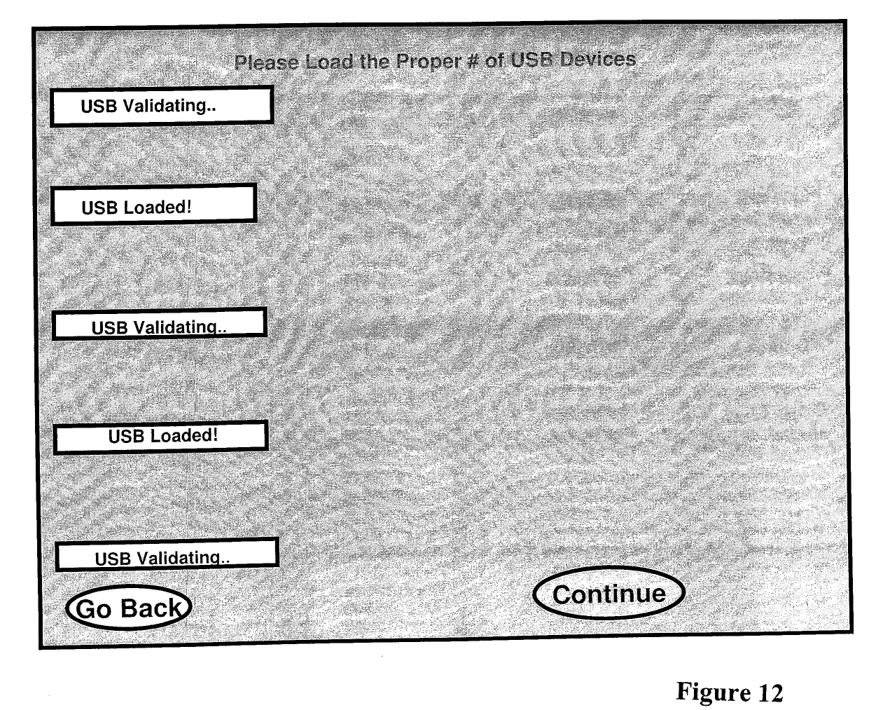

An administrator is queried on an administration computer with an action option menu as shown in FIG. 2, whether the relevant administrative action is creation of an examination, editing of an existing examination or the grading of an examination. Selection of “create an examination” results in a further selection option of creating a new examination with loaded creation software, or the importing into the drive of an existing examination as shown in FIG. 2a. It is understood that multiple drives are connected to a multiport system 100 (e.g., with 50 to 100 ports) as shown in FIG. 12 and are handled en masse, with USB drives 10 being connected to ports 100a via connectors 10a, with examination creation or importing and multiple choice question grading. An examination type is selected to permit the opening of selection boxes for multiple choice examinations or of text boxes or areas for the recognized entry of text entries such as for essay answers or fill in answers. The selection type is typically multiple choice based quested, essay based questions, or combinations of the two, as shown in FIG. 2b. FIG. 3 depicts selection of existing examinations for importing to the drives.

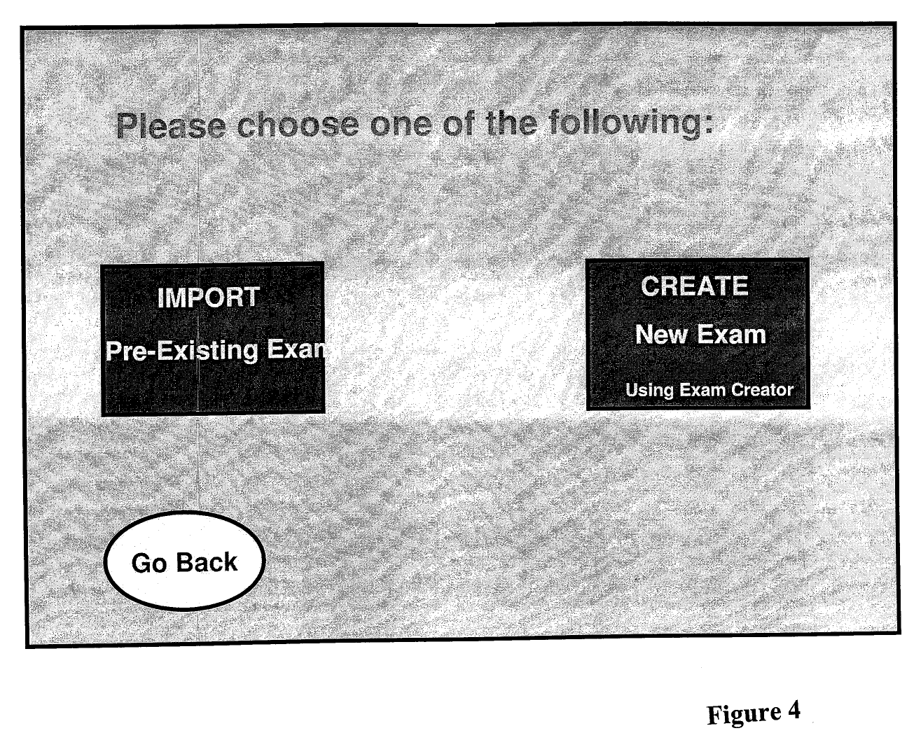

FIGS. 4a-c illustrate creation of a multiple choice examination. FIG. 4a shows an open document with a selection of multiple choice questions and a test creator field for insertion of questions in building up of an examination. FIG. 4b illustrates assignment of question ID and creation of an answer key for the selected questions and FIG. 4c illustrates the selected question listing in the test creator section.

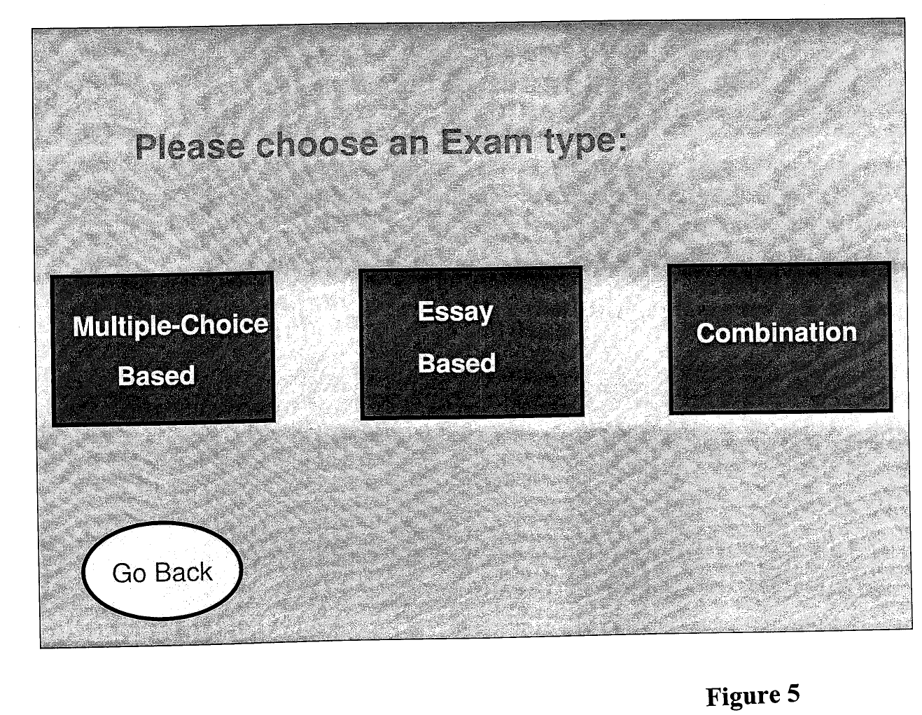

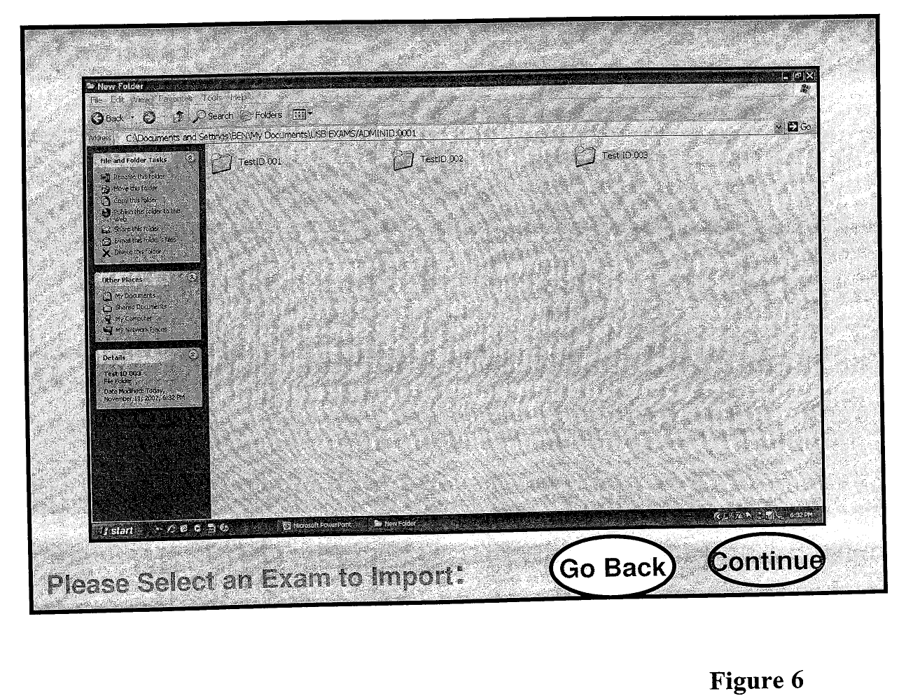

FIG. 5a details specification of examination parameters including number of test takers based on downloads to drives. FIG. 5b provides the option to load the prepared examination on the drives or to save it on the server for later use. Loading and validating to the selected number of USB devices is shown as being verified in FIG. 5c. FIG. 6a is an export grid with identification and test parameters for the various USBs to which the examination is downloaded.

FIG. 6b is the acknowledgement of effective test transfer to the USB device drives.

Though the examinations described herein and illustrated thus far are those of typical multiple choice questions and essays based on text problems, the configuration and method of the present invention also allows the use of any object that a test maker might want that is beyond what a normal test can do. For example, examinations may include audio files, video files, pictures in color as well as any media that may be developed in the future such as viable 3d graphical designs. These may be useful for examinations in the field of fashion, music, architecture and the like which require three dimensional depictions, color renderings and/or audio recognition.

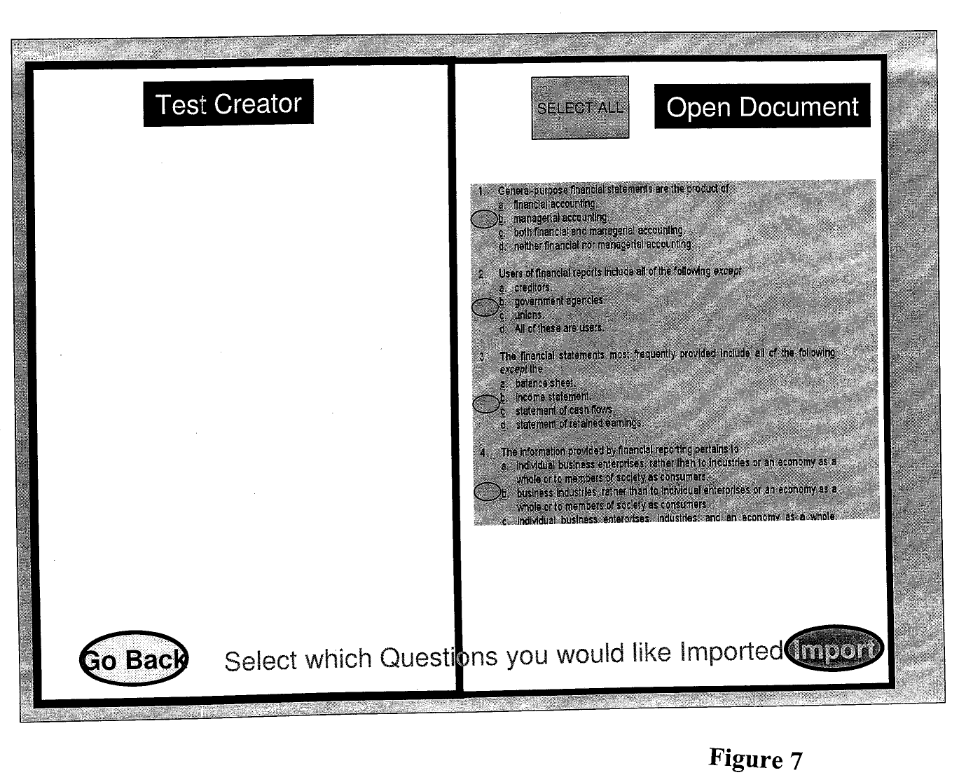

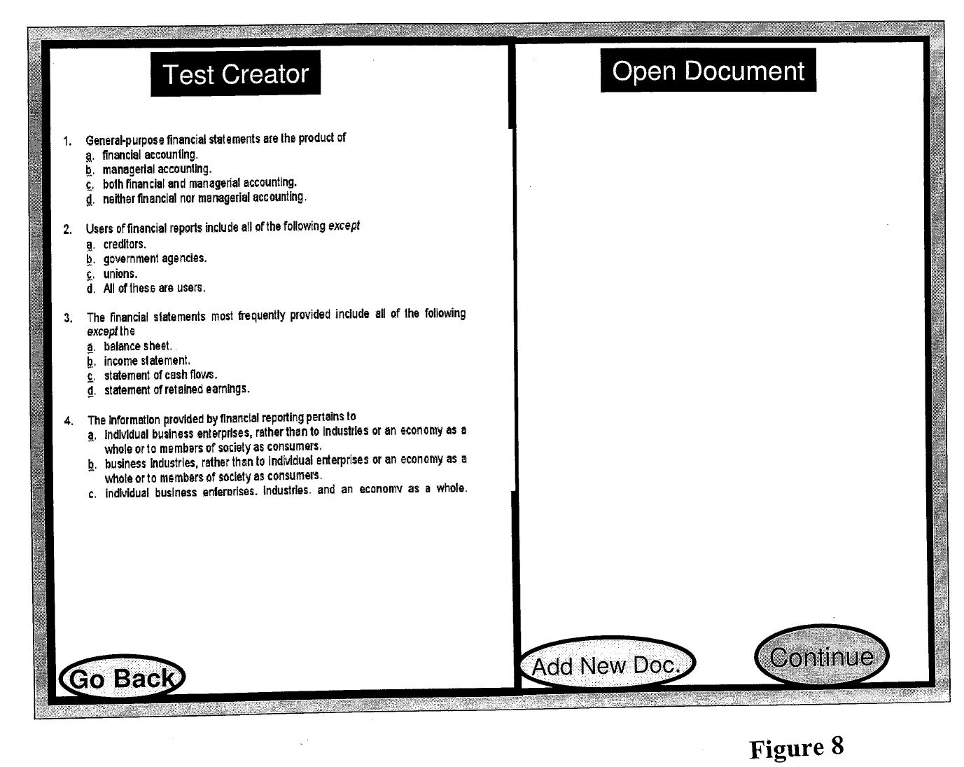

FIG. 7 is the instruction and introductory page directed to the test taker with information of local computer lock out during the examination and that tampering results in automatic test termination.

FIG. 8 is the multiple choice examination with fill-in boxes, a running test timer and the exhortation that the USB drive is to be returned to the administrator for after the test is completed for grading.

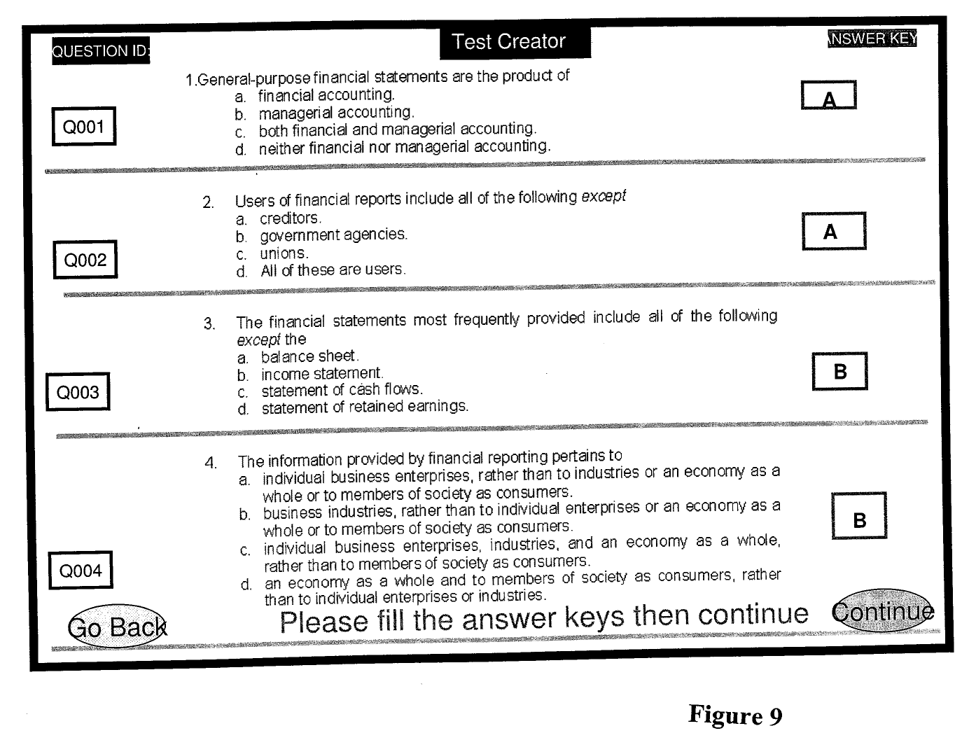

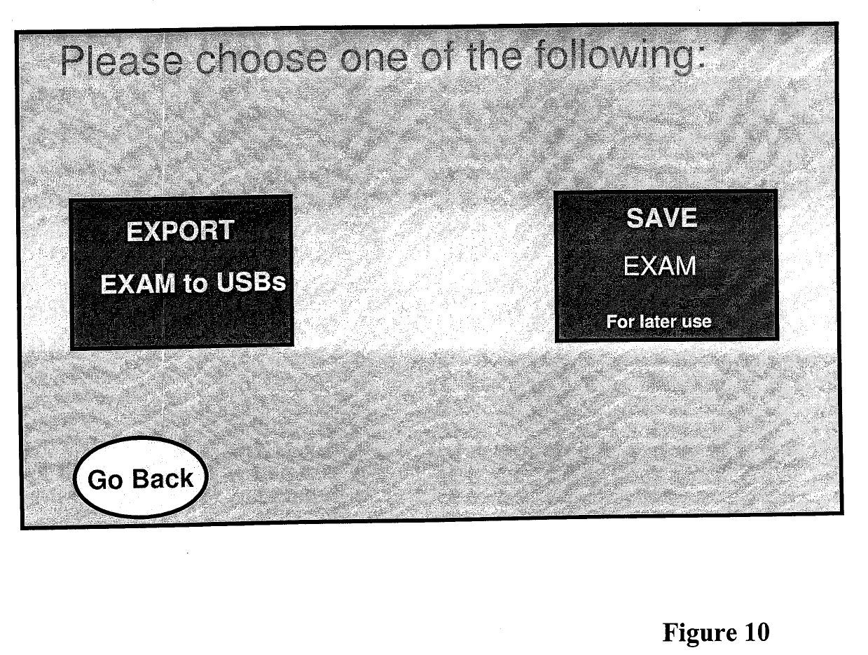

With return of the USB devices to the administrator after the taking of the examination, FIG. 9 illustrates the testing procedure with the selection of the examination to be graded. FIG. 10 is a validation and upload of the USB device to be graded.

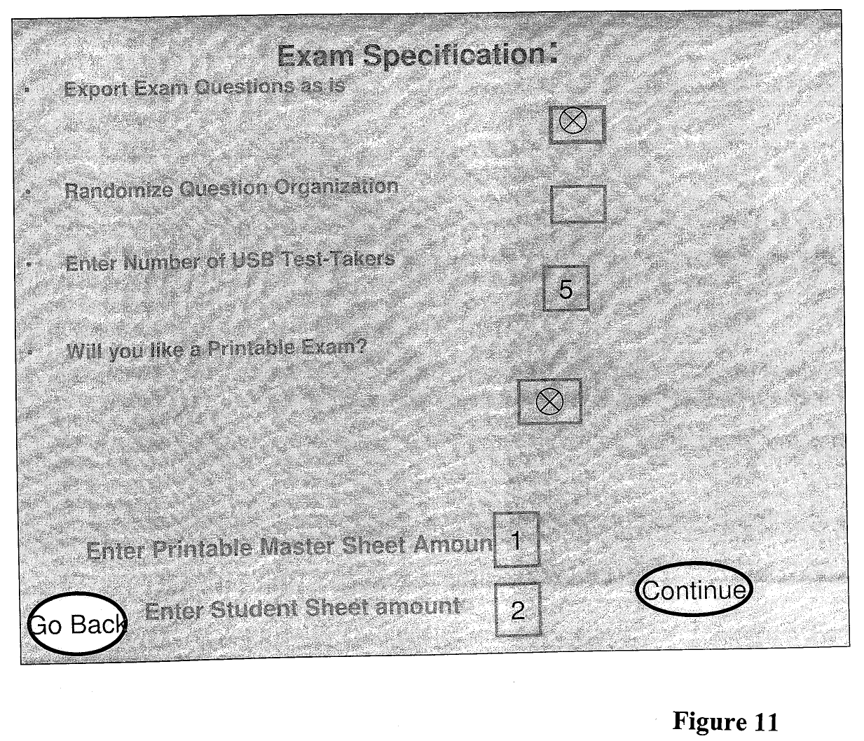

FIG. 11a is the preliminary USB drive grading grid with correlation of USB drive ID, test taker, administrator and specific test with checked validation and FIG. 11b is the grid of FIG. 11a with the entered grade correlated to the test taker, the test administrator and the specific examination as well as the USB drive which was used for examination and answer entry.

The correlation is maintained throughout the testing procedure and operation of the modules is only effected with appropriate ID and password entry. With removal of the USB drive from the notebook computer but not with simple rebooting of the computer without USB drive removal, the lock out software, resident on the drive, relinquishes control of the computer and normal operation resumes.

It is understood that the above description and embodiments shown are simply exemplary of the present invention and that changes in components, software, procedures and the like are within the scope of the present invention as defined in the following claims.

What is claimed is:

1. A method for computerized administration of examinations on a notebook computer comprising the steps of:
a) providing a portable computer drive element with unique identification to identify the drive element and a user thereof, the drive element being configured for removable attachment to the notebook computer,
b) loading the portable computer drive element with the software components of:
i. examination taking software configured to permit entry and saving of examination answers by an examination taker;
ii. identity software configured to permit entry data of a user of the drive element and to correlate user identity with the drive element and contents entered thereon
iii. computer lock out software to lock out all computer functions of the notebook computer, except those controlled by software on the drive element, when the computer drive element is connected to the notebook computer and the computer lock out software is activated; and
iv. an examination;
c) connecting the computer drive element to the notebook computer;
d) an examination taker taking the examination by:
a. logging in with identification data;
b. activating the lock out software and the examination taking software, and
c. selecting answers from a listing of choices and/or answering text based questions;
e) removing the computer drive element from the notebook computer and connecting the computer drive element to a reader device;
f) from the reader device validating examination details and linking entered contents on the computer drive element to the examination taker;
g) grading the examination; and
h) downloading the graded examination to an archive server.

2. The method of claim 1, wherein the examination taking software includes a word processing program and reference sources permitted for use during the examination.

3. The method of claim 1, wherein the method further includes the step of downloading security software to the drive element to detect tampering with the drive element.

4. The method of claim 1, wherein the method further includes the step of downloading reference material, permitted to be used by the examination taker, to the drive element.

5. The method of claim 1, wherein multiple drive elements are connected to a reader device for simultaneous loading of software and examinations to multiple drive elements.

6. The method of claim 5, wherein multiple drive elements are connected to a reader device for simultaneous grade examinations on the multiple drive elements.

7. The method of claim 1, wherein the downloaded security software includes the ability to load a new OS micro kernel off the drive elements to maintain lock out control of the computer on reboot of the computer.

8. The method of claim 1, wherein the drive elements are further loaded with software having the capability of launching a virtual computer or shell face interface for different operating systems

9. The method of claim 1, wherein the drive elements are selected from USB flash drives and secure digital (SD) cards.

10. The method of claim 9, wherein the drive elements have at least 300 megabytes of storage space.

11. A computerized self contained testing system configured for use in administering examinations on notebook computers, the system comprising three operational modules of:
a. examination preparation with portable drive elements operationally connectable to notebook computers, the individual portable drive elements having unique identifiers, and being simultaneously loaded with administrator identification and operational examination taking and security tamper detection software and computer function lock-out software; and an examination;
b. examination taking with the notebook computers onto the portable drive elements with examination taker identification entry, activation of computer function lock-out software and interactive entry of examination answers, as selected choices and/or text entry; and
c. examination grading and archiving with validation of the examination, correlation of the entered examination answers with an examination taker, and simultaneous marking of multiple examinations on multiple drive elements with subsequent uploading of grading results to an archival serve.

12. The computerized self contained testing system of claim 11, wherein the downloaded security software includes the ability to load a new OS micro kernel off the drive elements to maintain lock out control of the computer on reboot of the computer.

13. The method of claim 11, wherein the drive elements further comprise software having the capability of launching a virtual computer or shell face interface for different operating systems

14. The computerized self contained testing system of clam 11, wherein the portable drive elements are either a USB flash drive or a secure digital (SD) card.

15. A portable drive element for use in examination taking on a notebook computer, comprising a portable drive element selected from a USB flash drive and a secure digital (SD) card having contained in memory thereof examination taking software, administrator and examination taker ID information entry software, security software for detection of tampering, computer lock-out software and an examination.
